(19) United States
(12) Patent Application Publication
(10) Pub. No.: US 2004/0010681 A1
(43) Pub. Date: Jan. 15, 2004

(54) Method for shortening booting time of digital equipment having flash memory

(75) Inventor: Min-Ung Lee, Kumi-shi (KR)

Correspondence Address: Paul J. Farrell Esq., DILWORTH & BARRESE, LLP, 333 Earle Ovington Blvd., Uniondale, NY, 11553, US

(73) Assignee: SAMSUNG ELECTRONICS CO., LTD., Kyungki-Do (KR)

(21) Appl. No.: 10/378,008

(22) Filed: Mar. 3, 2003

(30) Foreign Application Priority Data
Jul. 10, 2002 (KR) 2002-39959

(51) Int. Cl. G06F 15/177

(52) U.S. Cl. 713/2

(57) ABSTRACT

Disclosed is a method for shortening a booting time of digital equipment having a flash memory. When digital equipment is powered on, a master file directory representing file information of user data and a sector state table representing a sector state of the flash memory are created with reference to each header of a plurality of file system blocks stored in a user data area. The master file directory and the sector state table are updated according to a modification made to the user data. When the digital equipment is powered off, the updated master file directory and sector state table are stored a reserved area. Then, the master file directory and the sector state table stored in the reserved area are loaded to the RAM when the digital equipment is powered on.

### PRIORITY

This application claims priority to an application entitled “Method for shortening Booting Time of Digital Equipment Having Flash Memory” filed in the Korean Industrial Property Office on Jul. 10, 2002 and assigned Serial No. 2002-39959, the contents of which are hereby incorporated by reference.

### BACKGROUND OF THE INVENTION

1. Field of the Invention

The present invention relates to digital equipment, and more particularly to a method for shortening booting time of digital equipment having flash memory.

2. Description of the Related Art

As the digital equipment industry makes great strides, the size of digital equipment becomes smaller and more compact. Accordingly, the size of a memory also becomes smaller and more compact.

Generally, digital equipments use a flash memory having a small size and low power consumption. The flash memory has advantages of a RAM (random access memory) and a ROM (read only memory), allowing data to be modified and stored even when the power is shut off. The flash memory can be densely integrated, so that it can be made small. In addition, access to data in the flash memory can be easily carried out with low power consumption and a short access time. The flash memory is light in weight and is durable against impact, so that it is adapted for a data storage medium in a mobile environment. The flash memory is used in various digital equipments including a digital camera, an electronic note, an MP3 (MPEG audio layer-3) player, and a mobile communication terminal such as a cellular phone and a PDA (personal digital assistants).

Hereinafter, a structure of a flash memory used in digital equipments will be described with reference to a flash memory used in the mobile communication terminal.

As shown in FIG. 1, a mobile communication terminal has two flash memories including a 32*32 memory 110 and a 16*16 memory 150. The 32*32 memory 110 stores data regarding an operation of the mobile communication terminal (for example, operating program), and the 16*16 memory 150 stores user data inputted by a user (for example, telephone numbers and character massages). In detail, referring to FIG. 1, the 32*32 memory 110 includes a boot sector 112 for storing data regarding a boot, a source binary sector 114 for storing data regarding the operating program, a check block sector 116 for checking the source binary area 114, a bell sector 118 for storing data regarding a bell, and a font sector 120 for storing data regarding a font of a character. In addition, the 16*16 memory 150 includes a user data area (0 sector-23 sector) 122 for storing data inputted by a user and a reserved area (23 sector-38 sector) 126, which is used when the size of the user data area 122 is insufficient.

Hereinafter, the 16*16 memory 150 will be described in detail with reference to FIG. 2. The user data area 122 includes a secured silicon sector (0 sector-7 sector) 128 for storing an ESN (electronic serial number), a real user data area (8 sector-21 sector) 124, and a reserved sector (22 sector) 130. A size of each sector is 64K bytes. As shown in FIG. 2, each sector has 256 blocks 132. In addition, one block has a size of 256 bytes and includes a fixed-format block header 134, a variable-format data portion 136, and a block checksum & data integrity code 138. The fixed-format block header 134 has a size of 10 bytes and represents a free block, an in-use block, and an obsolete block. The variable-format data portion 136 has a size of 242 bytes and stores real data. The block checksum & data integrity code 138 checks a state of the block and data integrity.

User data stored in the user data area of the flash memory is managed by using an EFS (embedded file system), which processes the user data in a file unit. The EFS creates a master file directory representing file information regarding user data and a sector state table representing the state of the sectors in the RAM whenever the mobile communication system is booted.

The master file directory is created in the RAM with reference to each header of the information. As shown in FIG. 3, the master file directory includes various file information. Each file information 170 includes a file ID (16 bits) 152, a reserved sector (8 bits) 154, an address of a file header block (16 bits) 156, a total file size in Byte (32 bits) 158, the total number of file blocks used (16 bits) 160, a saved file blocks information or an address of a remote file (32 bits) 162, a pointer to file block list (16 bits) 164, and a pointer to garbage block list (16bits) 166. By accessing the data files stored in the user data area 122 through file information as mentioned above, the user data can be created, deleted or corrected in a file unit.

In addition, whenever the user data, that is, data files are updated, the corresponding file information in the master file directory is updated and the sector state table representing the state of sectors is also updated. The sector state table, which is updated simultaneously with the master file directory, represents the present state of all sectors in user data area including the state of the free block, the in-use block, and the obsolete block. In detail, referring to FIG. 4, the number of the sector state table depends on the number of sectors in the user data area 122. One sector state table 190 includes a sum of block volatility value (32 bits) 172, an average of volatility value (32 bits) 174, a total number of blocks in this sector (16 bit) 176, a number of currently allocated blocks in this sector (16 bit) 178, a number of garbage blocks in this sector (16 bits) 180, a garbage blocks bit array 182, a garbage collection urgency rating (8 bits) 184, and a reserved sector (8 bits) 186. The sector state table constructed as mentioned above is updated simultaneously with the master file directory when the data files are updated.

When the mobile communication terminal is booted, the master file directory and the sector state table are created in the RAM as a fixed-format entry array.

In addition, when the mobile communication terminal is booted, the master file directory and the sector state table are created in the RAM by scanning the user data area four times. In detail, as shown in FIG. 5, a sector, which is subject to a garbage collection, is deleted when a first scanning step is carried out at step 2. That is, when the mobile communication terminal is powered off during the garbage collection, the sector subject to the garbage collection is deleted by checking the power-off state of the mobile communication terminal when booting the mobile communication terminal. In addition, an invalid block is inspected during a second scanning step at step 4. That is, the invalid block is checked by inspecting the integrity of header information of each block and data included in the block. In addition, file header blocks are added to the master file directory during a third scanning step at step 6. Then, data blocks are added to the master file directory during a fourth scanning step at step 8. At this time, a file block list representing file position information is created and unnecessary blocks are treated as garbage. When the above scanning steps have been finished, the master file directory and the sector state table are created in the RAM at step 10, and the booting is accomplished at step 12.

Like the mobile communication terminal, other digital equipments having the flash memory is booted in the same manner as described above.

The above booting method, however, takes a long time for booting digital equipments. Particularly, the fourth scanning step described at step 8, in which data blocks are added to the master file directory, the file block list representing file position information is created, and the unnecessary blocks are treated as garbage, takes a long time if great amount of user data is stored in the user data area, thereby delaying the booting time.

### SUMMARY OF THE INVENTION

Accordingly, to overcome the shortcomings of the prior art methods, there is provided a method for shortening a booting time of digital equipment having a flash memory.

In one aspect, a method for shortening a booting time of digital equipment having a flash memory divided into a user data area and a reserved area and a RAM comprises creating a master file directory representing file information of user data and a sector state table representing a sector state of the flash memory with reference to each head of a plurality of file system blocks stored in the user data area when digital equipment is powered on; updating the master file directory and the sector state table according to a variation of user data; storing the updated master file directory and sector state table in the reserved area when digital equipment is powered off; and loading the master file directory and the sector state table stored in the reserved area to the RAM when digital equipment is again powered on.

### BRIEF DESCRIPTION OF THE DRAWINGS

These and other features of the present invention will be more apparent from the following detailed description taken in conjunction with the accompanying drawings, in which:

FIG. 1 is a view showing a flash memory of a conventional mobile communication terminal [LABEL AS PRIOR ART];

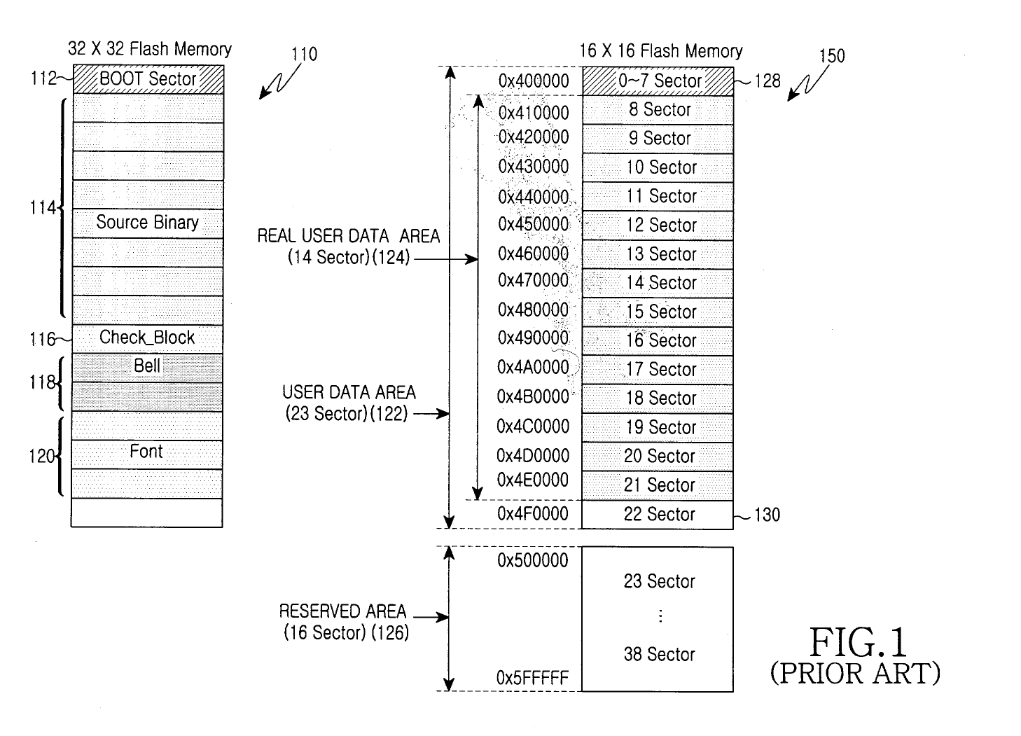

FIG. 2 is a view showing a user data area of a 16*16 flash memory shown in FIG. 1 [LABEL AS PRIOR ART];

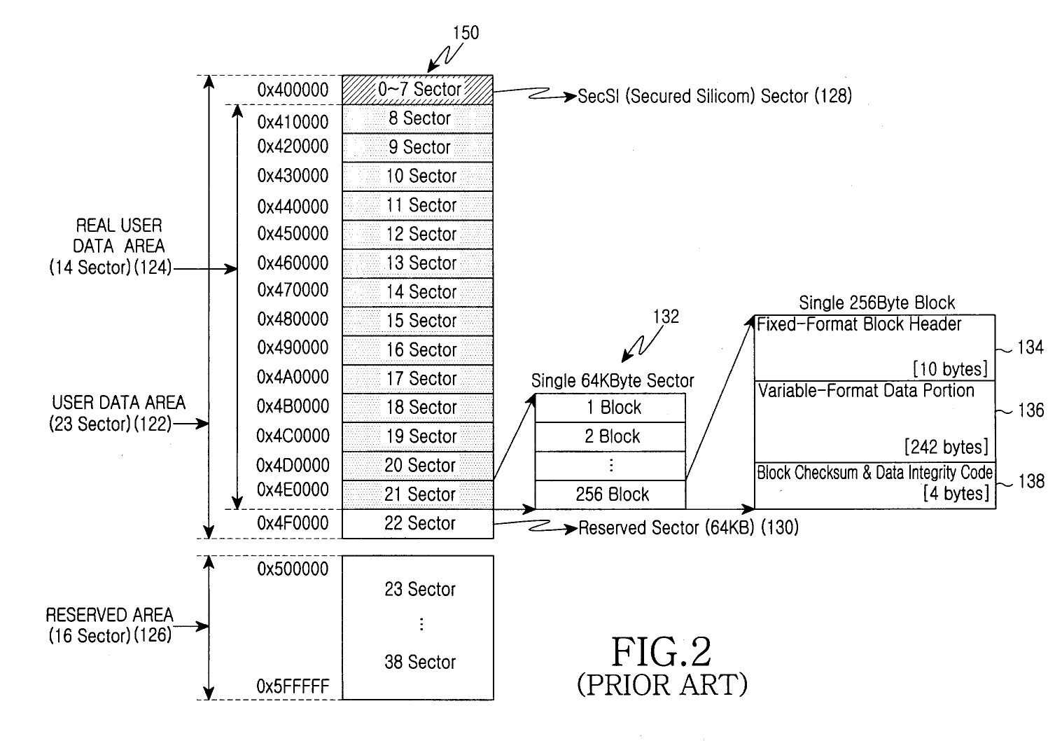

FIG. 3 is a view showing a master file directory of a conventional mobile communication terminal [LABEL AS PRIOR ART];

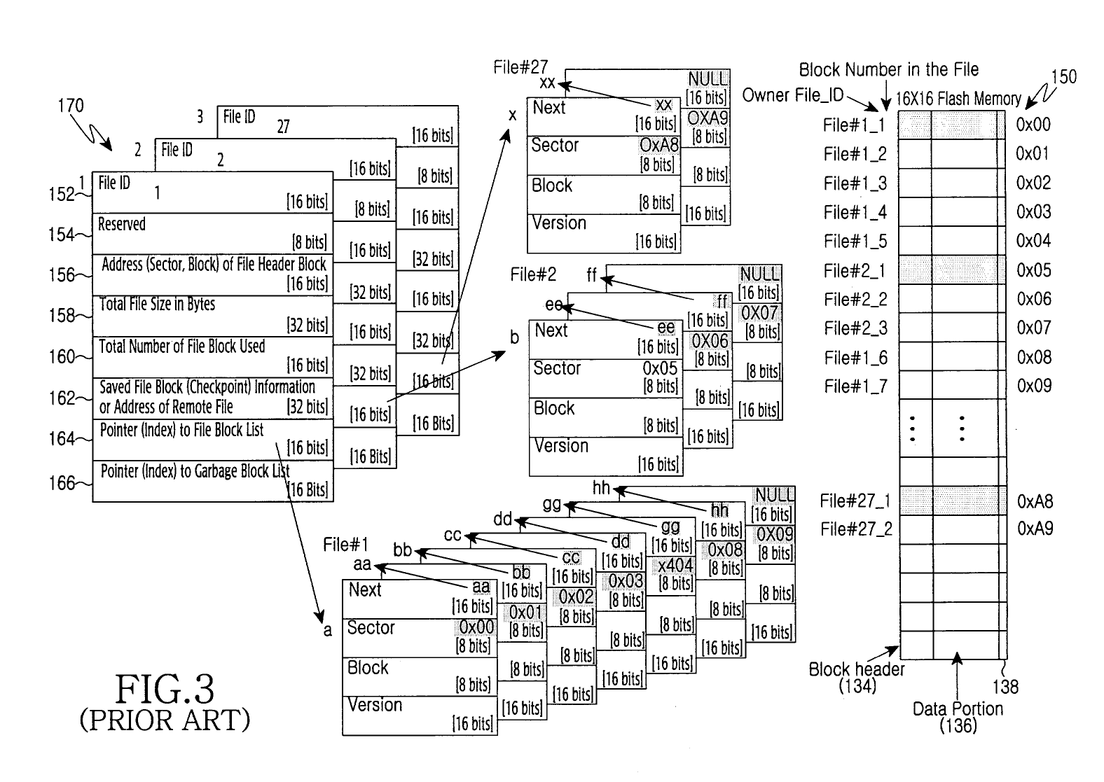

FIG. 4 is a view showing a sector state table of a conventional mobile communication terminal [LABEL AS PRIOR ART];

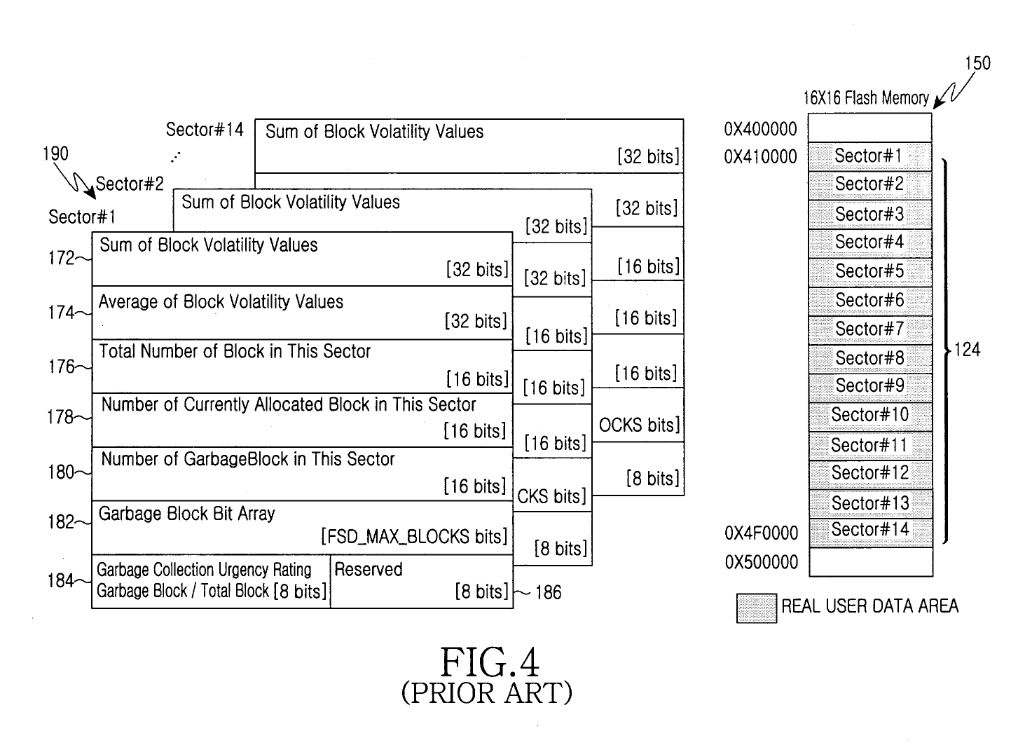

FIG. 5 is a flow chart showing a booting process of a conventional mobile communication terminal [LABEL AS PRIOR ART];

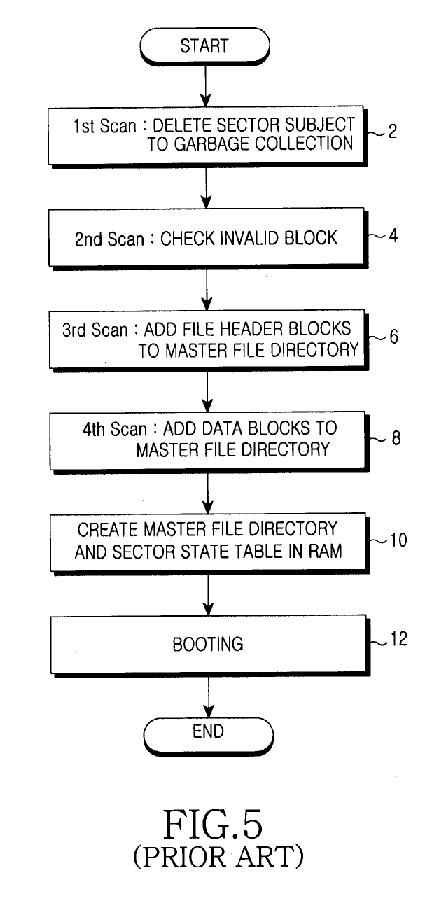

FIG. 6 is a block diagram of a mobile communication terminal according to one embodiment of the present invention; and

FIG. 7 is a flow chart showing a method for shortening a booting time of mobile communication terminal according to one embodiment of the present invention.

### DETAILED DESCRIPTION OF THE PREFERRED EMBODIMENT

Hereinafter, a preferred embodiment of the present invention will be described with reference to the accompanying drawings. In the following description of the present invention, a detailed description of known functions and configurations incorporated herein will be omitted when it may make the subject matter of the present invention rather unclear. The present invention is hereinafter described, in detail, with reference to a mobile communication terminal.

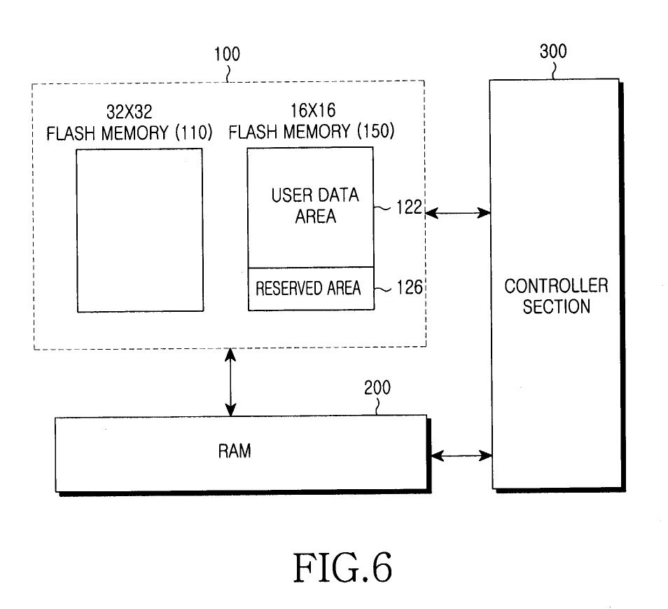

FIG. 6 is a block diagram of a mobile communication terminal according to one embodiment of the present invention. Referring to FIG. 6, the mobile communication terminal includes a flash memory 100, a RAM 200 and a control section 300.

The flash memory 100, as mentioned above, includes a 32*32 memory 110 for storing data regarding operation of the mobile communication terminal and a 16*16 memory 150 for storing user data inputted by a user. In addition, when the mobile communication terminal is powered off, the flash memory 100 stores a master file directory and a sector state table in a reserved area 126 according to a control of a control section 300.

The RAM 200 loads the master file directory and the sector state table therein based on the control of the control section 300, when the mobile communication terminal is powered on.

The control section 300 controls the operation of the mobile communication terminal, and updates the master file directory and the sector state table depending on the modification made to the user data. In addition, when the mobile communication terminal is powered off, the control section 300 stores the master file directory and the sector state table in the reserved area 126 of the flash memory 100. When the mobile communication terminal is again powered on, the control section 300 loads the master file directory and the sector state table, which are stored in the reserved area 126, to the RAM 200. In addition, when the mobile communication terminal is powered on after being powered off for a predetermined time due to a separation of a battery, the control section 30 creates the master file directory and the sector state table in the RAM 200.

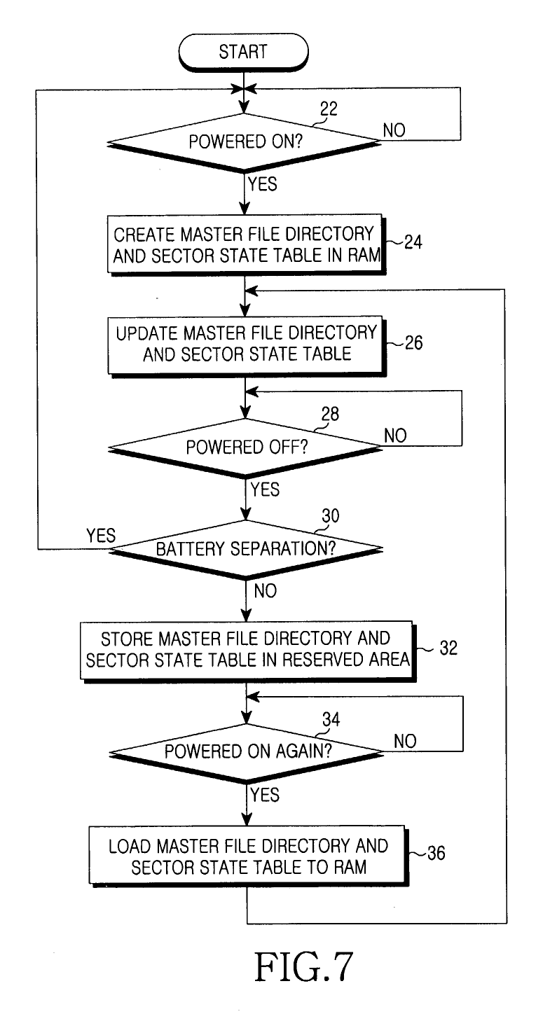

Hereinafter, a method for shortening the booting time in the mobile communication terminal having the above construction will be described with reference to FIG. 7. When the mobile communication terminal is powered on at (step 22, the control section 300 of the mobile communication terminal creates the master file directory and the sector state table in the RAM 200 with reference to each header of a plurality of file system blocks stored in the user data area 122 at step 24. At this time, as mentioned above, the control section 300 scans the user data area four times in order to create the master file directory and the sector state table in the RAM 200. Then at step 26, the control section 300 updates the master file directory and the sector state table, according to the modifications made to user data, for example, if a user creates, deletes or corrects data at. When the mobile communication terminal is powered off at step 28, the control section 300 stores the master file directory and the sector state table in the reserved area 126 of the flash memory 100 at step 32.

Then, when the mobile communication terminal is again powered on at step 34, the control section 300 loads the master file directory and the sector state table, which are stored in the reserved area 126, to the RAM 200 at step 36. That is, at step 36, the control section 300 does not create the master file directory and the sector state table in the RAM 200 through scanning steps, but copies the master file directory and the sector state table stored in the reserved area 126 into the RAM 200, thereby booting the mobile communication terminal. Thus, the mobile communication terminal can be easily booted.

At step 30, if the mobile communication terminal is again powered on after being powered off for a predetermined time due to a separation of a battery, the control section 30 creates the master file directory and the sector state table in the RAM 200 through scanning the user data area four times. The reason is that the mobile communication terminal is powered off before the control section 300 stores the master file directory and the sector state table in the reserved area 126.

By booting the mobile communication terminal through the above-mentioned manner, the booting time can be shortened as shown in Table 1.

TABLE

| sort | data size\No. | | 1 | 2 | 3 | 4 | 5 | mean (sec) |
|---|---|---|---|---|---|---|---|---|
| user | basic | normal | 3.524 | 3.543 | 3.526 | 3.510 | 3.522 | 3.525 |
| data | data | abnormal | 8.187 | 8.135 | 8.082 | 8.114 | 8.125 | 8.129 |
| area 4 M | user | normal | 5.343 | 5.276 | 5.281 | 5.296 | 5.278 | 5.295 |
| | data | abnormal | 14.328 | 14.338 | 14.338 | 14.332 | 14.330 | 14.333 |
| | 50% | | | | | | | |
| user | basic | normal | 3.824 | 3.814 | 3.819 | 3.815 | 3.814 | 3.817 |
| data | data | abnormal | 7.169 | 7.236 | 7.206 | 7.207 | 7.206 | 7.205 |
| area 6 M | user | normal | 5.407 | 5.413 | 5.411 | 5.409 | 5.283 | 5.385 |
| | data | abnormal | 12.119 | 11.858 | 11.776 | 11.778 | 11.680 | 11.842 |
| | 50% | | | | | | | |

In Table 1, a reference booting time is set as a time for displaying an animation after an initial image has been displayed on a screen. Basic data refers to user data not stored in the user data area, and user data 50% refers to user data occupying 50% of the user data area. Normal refers to a case when the mobile communication terminal has been powered off by means of a power key, and abnormal refers to a case when the mobile communication terminal has been powered off due to the separation of the battery.

By storing the master file directory and the sector state table in the reserved area and loading the master file directory and the sector state table to the RAM without creating them in the RAM, the booting can be easily achieved. While the present invention has been shown and described with reference to the mobile communication terminal, it will be understood by those skilled in the art that the present invention also can be adapted for digital equipments having a flash memory, such as a digital camera, an electronic note and MP3 player, without departing from the spirit and scope of the invention as defined by the appended claims.

What is claimed is:

1. A method for shortening a booting time of digital equipment having a flash memory divided into a user data area and a reserved area and a RAM, the method comprising the steps of:
creating a master file directory representing file information of user data and a sector state table representing a sector state of the flash memory with reference to each header of a plurality of file system blocks stored in the user data area when a digital equipment is powered on;
updating the master file directory and the sector state table according to one or more modifications made to the user data;
storing the updated master file directory and sector state table in the reserved area when the digital equipment is powered off; and
loading the master file directory and the sector state table stored in the reserved area to the RAM when the digital equipment is powered on.

2. A method as claimed in claim 1, wherein the creating step is carried out if the digital equipment is powered on after being powered off due to a separation of a battery from the digital equipment.
